(19) United States
(12) Patent Application Publication
(10) Pub. No.: US 2010/0054473 A1
(43) Pub. Date: Mar. 4, 2010

(54) Display Apparatus and Key Management Method

(75) Inventors: Naomiki Kobayashi, Ome-shi (JP); Hiroki Iwahara, Inagi-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/541,839

(22) Filed: Aug. 14, 2009

(30) Foreign Application Priority Data
Sep. 3, 2008 (JP) 2008-226141

(51) Int. Cl. H04L 9/00

(52) U.S. Cl. 380/270; 380/277

(57) ABSTRACT

According to one embodiment, a display apparatus includes a card slot configured to be insertable a memory card including a user data area in which one or more encrypted content keys encrypted with a user key and list information of content-specific information unique to each of content items corresponding to the respective encrypted content keys are stored, a close-proximity wireless transfer device configured to be able to transfer with an external device, an information acquisition module configured to acquire the content-specific information of content held by the external device with which the close-proximity wireless transfer device is executing close-proximity wireless transfer, a content-specific information detection module configured to detect the content-specific information corresponding with information indicating the acquired content, from the list information stored in the user data area, and a display processing module configured to display a list of content items corresponding to the detected content-specific information.

### CROSS-REFERENCE TO RELATED APPLICATIONS

This application is based upon and claims the benefit of priority from Japanese Patent Application No. 2008-226141, filed Sep. 3, 2008, the entire contents of which are incorporated herein by reference.

### BACKGROUND

1. Field

One embodiment of the invention relates to a display apparatus for displaying a list of decodable encrypted content by using an encrypted content key, and a key management method.

2. Description of the Related Art

SD-SD (SD—Separate Delivery), which is capable of separately managing encrypted copyright-protected content and content keys for decoding the copyright-protected content, is standardized by SD Card Association.

In SD-SD, content itself is encrypted to be stored in a large capacity storage device such as a personal computer, and a content key can be carried separately by being saved in an SD memory card.

Jpn. PCT National Publication No. 2008-513915 discloses an art in which a content identifier is added to a recording medium and a key is stored in another recording medium that is copy protected, and the content identifier and the key are compared.

However, as the number of storage devices for saving content keys such as SD memory cards increases, it becomes hard to tell which content key is saved in which storage device. In order to check, a user has to physically connect a storage device to a personal computer (external device), which is inconvenient.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing external views of a mobile phone as a display apparatus and three notebook computers, according to one embodiment of the present embodiment;

FIG. 2 is an exemplary block diagram showing an example of a system configuration of a mobile phone according to the embodiment of the present invention;

FIG. 3 is an exemplary block diagram showing a system configuration of a personal computer as a wireless transfer device according to the embodiment of the present invention;

FIG. 4 is an exemplary diagram for explaining data stored in a hard disk drive of the computer shown in FIG. 3;

FIG. 5 is an exemplary diagram for explaining data stored in a memory card inserted in a card slot of the mobile phone shown in FIG. 2;

FIG. 6 is an exemplary diagram showing a data structure of a content ID list stored in the hard disk drive of the computer;

FIG. 7 is a diagram showing a data structure of content key management information stored in the memory card of the mobile phone;

FIG. 8 is an example of content meta-information stored in a user data area of the memory card;

FIG. 9 is an exemplary diagram for explaining a procedure for the mobile phone to search for a content key from the content ID list in which content ID values of encrypted content, which is stored in the hard disk drive of the computer, are stored;

FIG. 10 is an exemplary diagram for explaining data exchange performed between a mobile phone and a computer;

FIG. 11 is an exemplary block diagram showing a configuration for displaying a list of content corresponding to a combination of the mobile phone and the computer; and

FIG. 12 is an exemplary diagram showing an example of a content list displayed on a display screen of a liquid crystal display of the mobile phone.

### DETAILED DESCRIPTION

Various embodiments according to the invention will be described hereinafter with reference to the accompanying drawings. In general, according to one embodiment of the invention, a display apparatus comprises a display device including a display screen, a card slot configured to be insertable a memory card, the memory card including a user data area in which one or more encrypted content keys encrypted with a user key and list information of content-specific information unique to each of content items corresponding to the respective encrypted content keys are stored, a close-proximity wireless transfer device configured to be able to communicate with an external device including the one or more content items in a peer-to-peer format, an information acquisition module configured to acquire the content-specific information of content held by the external device with which the close-proximity wireless transfer device is executing close-proximity wireless transfer, a content-specific information detection module configured to detect the content-specific information corresponding with information indicating the acquired content, from the list information stored in the user data area, and a display processing module configured to display a list of content items corresponding to the detected content-specific information on the display screen of the display device.

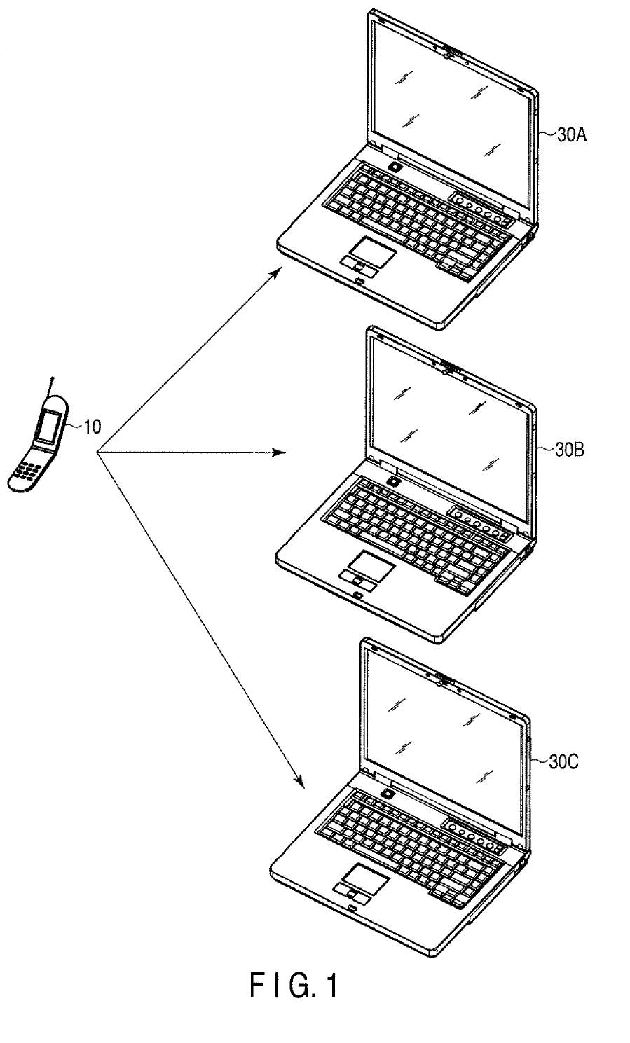

FIG. 1 is a perspective view showing external views of a mobile phone 10 as a display apparatus and notebook computers 30A, 30B, 30C, according to one embodiment of the present embodiment.

Each of the mobile phone 10 and the computers 30A-30C has a close-proximity wireless transfer function.

The mobile phone 10 and one of the computers 30A-30C execute close-proximity wireless transfer. The close-proximity wireless transfer is a kind of near-field communication (NFC). The close-proximity transfer between the mobile phone 10 and one of the computers 30A-30C is performed in a peer-to-peer format. Transferable distance is, for example, 3 cm. Wireless connection between the mobile phone 10 and one of the computers 30A-30C is possible only when a distance between the two is within a transferable distance (e.g., 3 cm). When one of the computers 30A-30C comes close to the mobile phone 10 within the transferable distance, a connection between the mobile phone 10 and said one of the computers 30A-30B is established.

An induced electric field is used in the close-proximity wireless transfer. As a close-proximity wireless transfer method, for example, Transfer JET may be used. Transfer JET is a close-proximity wireless transfer method utilizing UWB capable of realizing a high-speed data transfer.

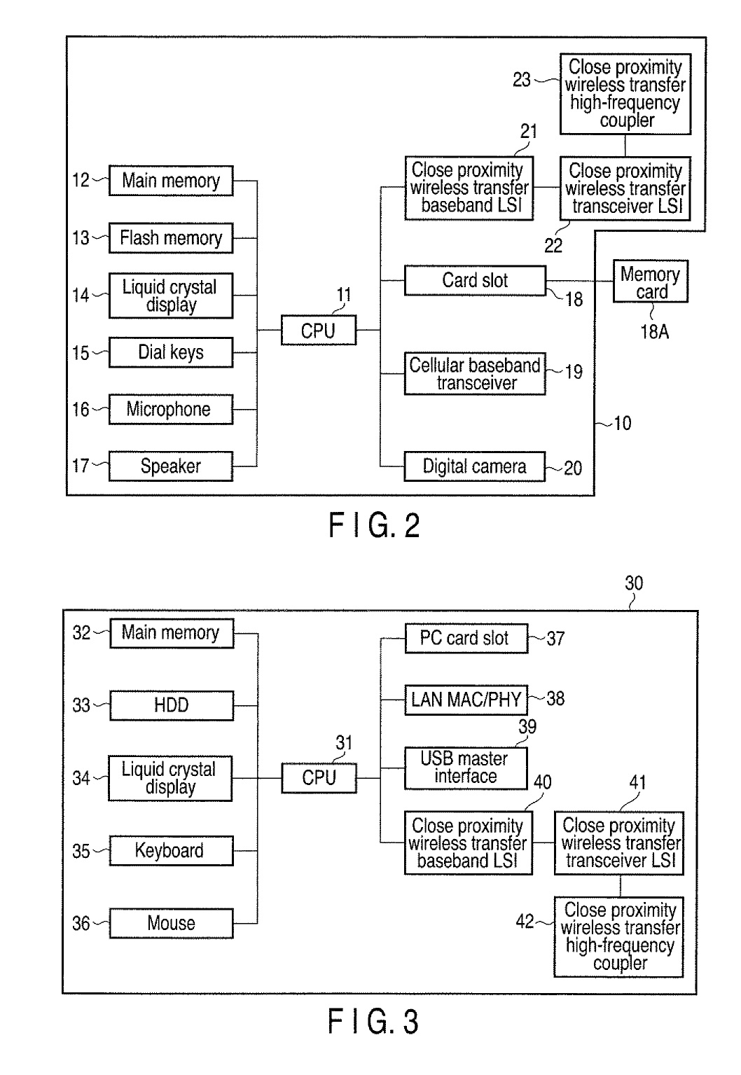

FIG. 2 is a block diagram showing an example of a system configuration of the mobile phone 10 according to the embodiment of the present invention.

As shown in FIG. 2, the mobile phone 10 includes a CPU 11, a main memory 12, a flash memory 13, a liquid crystal display 14, dial keys 15, a microphone 16, a speaker 17, a card slot 18, a cellular baseband transceiver 19, a digital camera 20, a close-proximity wireless baseband LSI 21, a close-proximity wireless transceiver LSI 22, and a close-proximity wireless high-frequency coupler 23.

The CPU 11 is a processor for controlling performance of the mobile phone, and it executes various application programs loaded to the main memory 12, such as an operating system (OS), a mailer, backup data transmission software and the like.

The flash memory 13 is a place in which data files obtained by a user are stored. For example, an address book, mail data files, image data files shot by the digital camera 20 are stored in the flash memory 13.

The dial keys 15 are provided for inputting telephone numbers and characters by user operation.

The card slot 18 is a slot wherein the memory card 18A is insertable. The cellular baseband transceiver 19 is a circuit provided for performing communication with a base station.

The close-proximity wireless baseband LSI 121 is an LSI for executing a baseband signal process for close-proximity wireless transfer. The close-proximity wireless transceiver LSI 22 is an LSI for executing input and output of high-frequency signals for the close-proximity wireless transfer. The close-proximity wireless high-frequency coupler 23 is an antenna configuring an induced electric field coupling for the close-proximity wireless transfer. The close-proximity wireless high-frequency coupler 23 converts an induced electric field transmitted from the computer 30 into a high-frequency signal, or transmits a high-frequency signal supplied from the close-proximity wireless transceiver LSI 22 as an induced electric field.

FIG. 3 is a block diagram showing a system configuration of a personal computer 30 (30A-30C) serving as a wireless transfer device according to the embodiment of the present invention.

As shown in FIG. 3, the personal computer 30 includes a CPU 31, a main memory 32, a hard disk drive (HDD) 33, a liquid crystal display 34, a keyboard 35, a mouse 36, a PC card slot 37, a LAN MAC/PHY 38, a USB master interface 39, a close-proximity wireless baseband LSI 40, a close-proximity wireless transceiver LSI 41, and a close-proximity wireless high-frequency coupler 42.

The CPU 31 is a processor for controlling performance of the computer 30, and it executes an operating system (OS) and various application program loaded to the main memory 32.

Into the PC card slot 37, a PC card of PCMCIA standard is insertable. Also, the LAN MAC/PHY 38 is a chip for executing communication with other devices via a network such as Ethernet™.

The close-proximity wireless baseband LSI 21 is an LSI for executing a baseband signal process for the close-proximity wireless transfer. The close-proximity wireless transceiver LSI 41 is an LSI for executing input and output of high-frequency signals for the close-proximity wireless transfer. The close-proximity wireless high-frequency coupler 42 is an antenna configuring an induced electric field coupling for the close-proximity wireless transfer. The close-proximity wireless high-frequency coupler 42 converts an induced electric field transmitted from the mobile phone 10 into a high-frequency signal, or transmits a high-frequency signal supplied from the close-proximity wireless transceiver LSI 41 as an induced electric field.

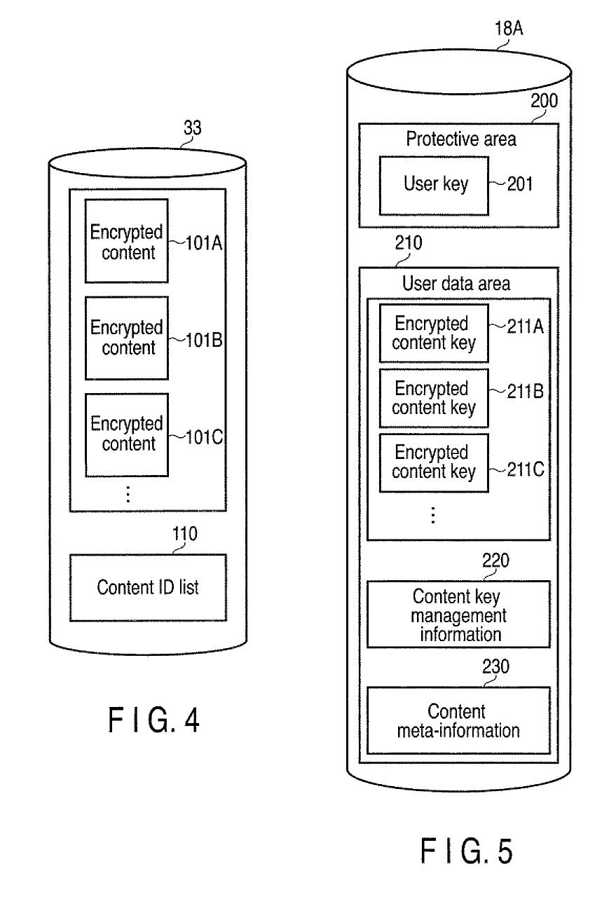

Next, data stored in the HDD 33 of the computer 30 will be explained with reference to FIG. 4.

The HDD 33 of the computer 30 includes content items 101A, 101B, 101C, . . . encrypted with content keys, and a content ID list 110 for associating the encrypted content items 101A, 101B, 101C, . . . with the content keys. The content key means a key itself that encrypts the content.

Next, data stored in the memory card 18A inserted into the card slot 18 of the mobile phone 10 will be explained with reference to FIG. 5.

The memory card 18A of the mobile phone 10 comprises a protective area 200 which cannot be normally accessed by a user, and a user data area 210 which can be normally accessed by a user. Storage devices such as an SD card have similar structures.

The user data area 210 of the memory card 18A of the mobile phone 10 stores encrypted content keys 211A, 211B, 211C, . . . , which are the content keys that have been encrypted, and content key management information 220 for associating the encrypted content keys 211A, 2118, 211C, . . . with the content. The encrypted content keys 211A, 211B, 211C, . . . are not stored in plain text everybody can use, but saved in a condition encrypted with a user key 201. The user key 201 is stored in the protective area 200. The content key management information 220 is also stored in the user data area 210. The information 220 is stored in plain text, not in an encrypted condition.

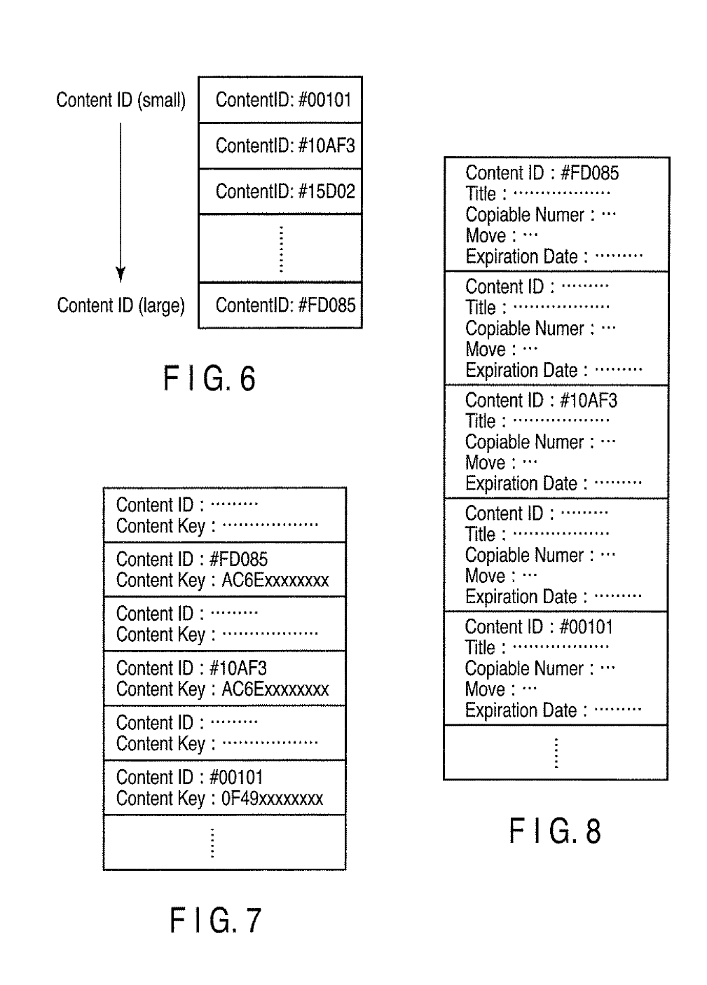

Next, meta-information for associating a content body with a content key. FIG. 6 is a diagram showing a data structure of a content ID list 110 stored in the hard disk drive 33 of the computer 30. The content ID list 110 has a list structure in which content ID values (content-specific information) unique to respective content items are arranged in ascending order. The content ID values are unique values generated from respective content bodies. In the content ID list 110, the content ID values and the encrypted content items are in a one-to-one correspondence, and they can be searched bidirectionally.

FIG. 7 is a diagram showing a data structure of the content key management information 220 stored in the memory card 18A of the mobile phone 10. The content key management information 220 is for associating the encrypted content with the encrypted content keys 101A, 101B, 101C for the respective encrypted content items, and the information 220 has a table structure comprising content IDs and the encrypted content keys.

Next, content meta-Information 230 stored in the user data area 210 of the memory card 18A will be explained with reference to FIG. 8. As shown in FIG. 8, title, copiable number, move, and expiration date are associated with each of the content ID values. Usage rules of content such as copiable number, move, expiration date and the like are encrypted.

The memory card 18A storing the encrypted content keys 211A, 211B, 211C, . . . does not have to store encrypted content. When encrypted content is stored in a plurality of computers 30A-30C as shown in FIG. 1, it is not easy to tell which content can be reproduced, depending on combinations of the computers 30A-30C and the memory card in the mobile phone 10.

According to the mobile phone 10 of the present embodiment, the close-proximity wireless transfer is performed between the mobile phone 10 and a computer selected from the computers 30A-30C by putting the mobile phone 10 on the selected computer. The mobile phone 10 displays, on a display screen of the liquid crystal display 14, a list of content items corresponding to a combination of the mobile phone 10 and the computer performing the close-proximity wireless transfer with the mobile phone 10.

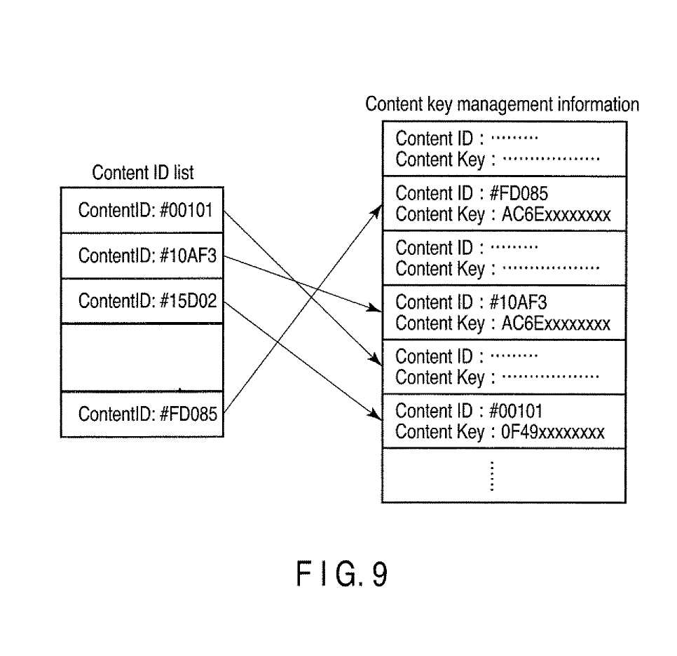

FIG. 9 explains a procedure for the mobile phone 10 to search for a content key from the content ID list 110 in which content ID values of encrypted content items 101A, 101B, 101C, . . . , which are stored in the computer 30, are stored. After a content ID value of a target content is searched from the content ID list 110, a field corresponding to the searched content ID value is searched in the content key management information 220. When the search finds a match, an encrypted content key corresponding to the matched ID can be obtained from the content key management information 220.

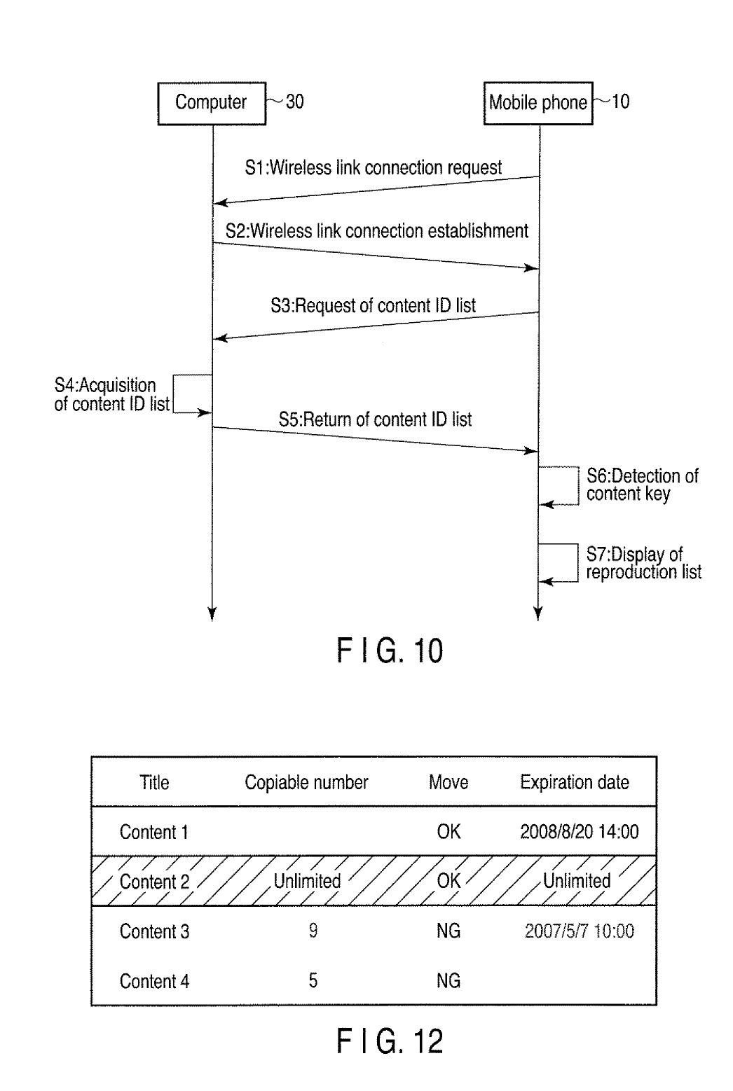

FIG. 10 shows data exchange performed between the mobile phone 10 and the computer 30. When the mobile phone 10 is touched on a chassis surface of the computer 30, a link connection for the close-proximity wireless transfer is firstly established (S1-S2). Then the mobile phone 10 starts a protocol, and transmits a request to ask for all of the content IDs relating to the content stored in the computer 30 (S3). The computer 30 sends back its own content ID list to the mobile phone 10 (S4-S5). When the mobile phone 10 receives the content ID list, it becomes able to obtain content keys corresponding to respective content IDs, as shown in FIG. 9 (S6). Only content items whose corresponding content keys are obtained based on the content IDs can be played depending on combinations of the mobile phone 10 and the computers 30. Also, content meta-information such as titles can be obtained at the same time because the encrypted content keys and the content meta-information are managed in pairs. When the mobile phone 10 obtains the content meta-information based on the content ID, it displays, on the liquid crystal display, titles etc. corresponding to the combination of the phone 10 and the computer 30 (S7).

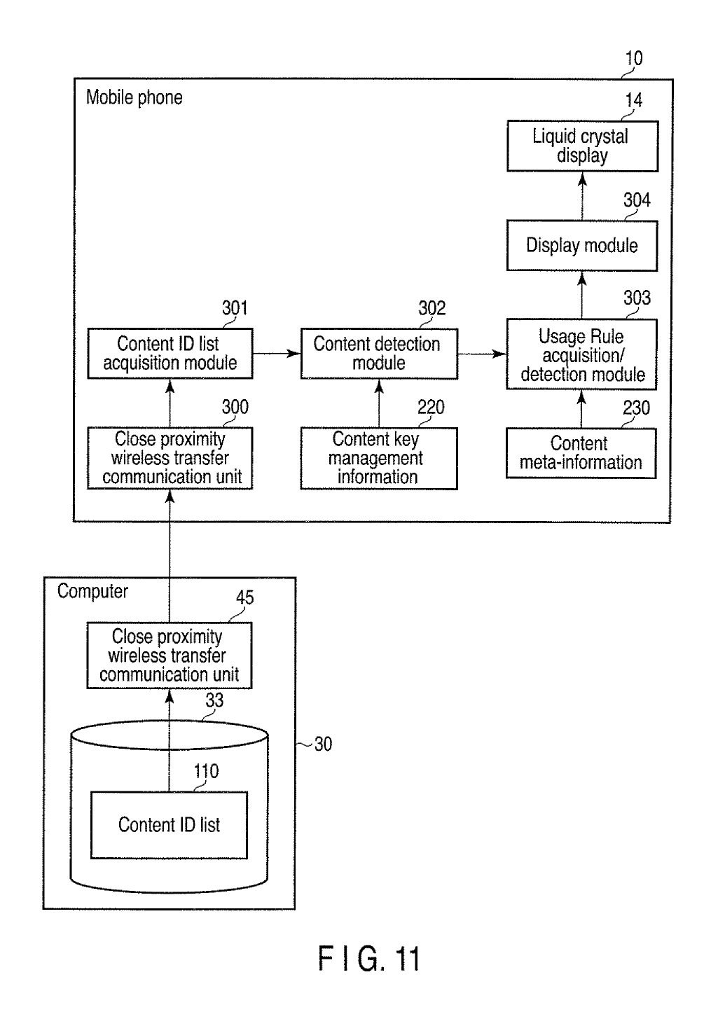

Next, a configuration for displaying a content list corresponding to the combination of the mobile phone 10 and the computers 30 will be explained with reference to FIG. 11.

As shown in FIG. 11, the mobile phone 10 comprises a close-proximity wireless transfer unit 300, a content ID list acquisition module 301, a content detection module 302, a usage rule acquisition module 303, a display module 304, and the liquid crystal display 14.

The close-proximity wireless transfer unit 300 is a unit for executing close-proximity wireless transfer, and comprising a close-proximity wireless baseband LSI 21, a close-proximity wireless transfer transceiver LSI 22, and a close-proximity wireless high-frequency coupler 23.

The content ID list acquisition module 301 executes a process for acquiring the content ID list 110 stored in the hard disk drive 33 of the computer 30.

The content detection module 302 compares the content ID list 110 obtained by the content ID list acquisition module 301 with the content key management information 220, and executes a process for detecting (extracting) a content ID included in the content ID list 110 from among content IDs included in the content key management information 220.

The usage rule acquisition module 303 refers to the content meta-information 230 on the basis of the content ID detected (extracted) by the content detection module 302, and executes a process for acquiring a title and a usage rule of the detected (extracted) content ID. The usage rule acquisition module 303 then hands data indicating the acquired title and usage rule over to the display module 304.

The display module 304 generates data for displaying, on the liquid crystal display 14, a list of content corresponding to the combination of the mobile phone 10 and the computer 30 on the basis of the handed data, and transmits the generated data to the liquid crystal display 14.

Also, a close-proximity wireless transfer unit 45 provided in the computer 30 is a unit for executing close-proximity wireless transfer.

The close-proximity wireless transfer unit 45 comprises the close-proximity wireless baseband LSI 40, the close-proximity wireless transceiver LSI 41, and the close-proximity wireless high-frequency coupler 42.

FIG. 12 shows an example of a content list displayed on the display screen of the liquid crystal display 14 of the mobile phone 10. This figure indicates an example of a content list corresponding to the combination of the mobile phone 10 and the computer 30. It includes usage rule information such as copy control information and expiration dates of content in addition to content titles, and these pieces of information are displayed together, which is convenient for a user. Normally, a usage rule is saved in pair with a content key and stored in the user data area in a condition encrypted with a user key. Thus, the usage rule has to be decoded for being displayed. A user may set the mobile phone 10 in such a manner that the mobile phone 10 does not display content items whose expiration dates have been exceeded so that only reproducible content will be displayed in the list.

Furthermore, with regard to those content items (e.g., content 3) whose expiration dates have been exceeded and not reproducible, it is preferable that those items be made distinguishable for warning the user by, for example, displaying those items in red.

A user is enabled to confirm reproducible content by displaying, on the liquid crystal display 14, the list of the encrypted content items corresponding to the content keys stored in the memory card, on the basis of the encrypted content stored in the hard disk drive of the computer connected to the mobile phone in peer-to-peer transfer.

Specifically, the user is able to know which encrypted content keys stored in the storage device such as a memory card are for which content items, simply with an intuitive operation such as touching the mobile phone 10 to the computer 30 when the close-proximity wireless transfer is used.

In the above embodiment, the close-proximity wireless transfer (e.g., Transfer JET) is given as a device for executing transfer in a peer-to-peer format. However, other methods may be used as long as a method wherein transfer is executed in a peer-to-peer format is used. For example, communication in a Bluetooth™ format may be used.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display apparatus comprising:
a display device including a display screen;
a card slot configured to be insertable a memory card, the memory card including a user data area in which one or more encrypted content keys encrypted with a user key and list information of content-specific information unique to each of content items corresponding to the respective encrypted content keys are stored;
a close-proximity wireless transfer device configured to be able to transfer with an external device including the one or more content items in a peer-to-peer format;
an information acquisition module configured to acquire the content-specific information of content held by the external device with which the close-proximity wireless transfer device is executing close-proximity wireless transfer;
a content-specific information detection module configured to detect the content-specific information corresponding with information indicating the acquired content, from the list information stored in the user data area; and
a display processing module configured to display a list of content items corresponding to the detected content-specific information on the display screen of the display device.

2. The display apparatus of claim 1, wherein
the user data area stored a information indicating a usage rule for the content-specific information is stored in,
the display apparatus further comprises a playable content detection module configured to detect, by referring to the information indicating the usage rule for the content-specific information, content-specific information whose content is playable depending on a combination of the display apparatus and the external device with which the display apparatus is executing close-proximity wireless transfer, on the basis of the content-specific information detected by the content-specific information detection module, and
the display processing module configured to display a list of content corresponding to the content-specific information detected by the playable content detection module on the display screen of the display device.

3. The display apparatus of claim 1, wherein
the user data area store information indicating a usage rule for content-specific information is stored,
the display apparatus further comprises an unplayable content detection module configured to detect, by referring to the information indicating the usage rule for the content-specific information, content-specific information whose content is not reproducible depending on a combination of the display apparatus and the external device with which the display apparatus is executing close-proximity wireless transfer, and
the display processing module executes a process for displaying a list of the content items corresponding to content-specific information detected by the unplayable content detection module, on the display screen of the display device, in such a manner that the content can be distinguished from other content.

4. The display apparatus of claim 1, wherein
the user data area store information indicating a usage rule for content-specific information, and
the display processing module refers to information indicating the usage rule for the content-specific information, and displays a usage rule for the detected content in the list.

5. The display apparatus of claim 1, wherein
the user data area store information indicating a title, which corresponds to the encrypted content key stored in the user data area, and
the display processing module displays the title of the detected content in the list.

6. A key management method for a display apparatus comprising a card slot configured to be insertable a memory card including a user data area in which one or more encrypted content keys encrypted with a user key and list information of content-specific information unique to each of content items corresponding to the respective encrypted content keys are stored, and a close-proximity wireless transfer device configured to be able to transfer with an external device including the one or more content items in a peer-to-peer format, the key management method comprises:
acquiring content-specific information of the one or more content items held by an external device to which the close-proximity wireless transfer device is executing close-proximity wireless transfer;
detecting content-specific information corresponding with information indicating the acquired content, from the list information stored in the user data area; and
displaying a list of content items corresponding to the detected content-specific information on a display device of a display device.

7. The key management method of claim 6, wherein
the user data area stores information indicating a usage rule for content-specific information,
the method further comprising:
detecting content-specific information, whose content is playable depending on a combination of the display apparatus and the external device with which the display apparatus is executing close-proximity wireless transfer, from the content-specific information detected by a content-specific information detection module, by referring to the information indicating the usage rule for the content-specific information; and
displaying a list of content corresponding to the content-specific information detected by a playable content detection module on the display screen of the display device.

8. The key management method of claim 6, wherein
the user data area stores information indicating a usage rule for content-specific information,
the method further comprising:
detecting content-specific information, whose content is unplayable depending on a combination of the display apparatus and the external device with which the display apparatus is executing close-proximity wireless transfer, by referring to the information indicating the usage rule for the content-specific information; and
displaying a list of the content corresponding to content-specific information detected by an unplayable content detection module on the display screen, in such a manner that the content can be distinguished from other content.

9. The key management method of claim 6,
wherein the user data area stores information indicating a usage rule for content-specific information, and
the method further comprises displaying usage rule of the detected content in the list, by referring to information indicating usage rule for the content-specific information.

10. The key management method of claim 6,
wherein the user data area stores information on titles which correspond to the one or more encrypted key stored in the user data area, and
the method further comprises displaying titles of the detected content items in the list.
